(19) United States
(12) Patent Application Publication
(10) Pub. No.: US 2025/0310839 A1
(43) Pub. Date: Oct. 2, 2025

(54) METHODS AND APPARATUS FOR PERFORMING A HANDOVER IN A WIRELESS COMMUNICATION SYSTEM

(71) Applicant: SAMSUNG ELECTRONICS CO., LTD., Suwon-si (KR)

(72) Inventors: Weiwei WANG, Beijing (CN); Zhe CHEN, Beijing (CN); Hong WANG, Beijing (CN); Lixiang XU, Beijing (CN)

(21) Appl. No.: 19/054,067

(22) Filed: Feb. 14, 2025

(30) Foreign Application Priority Data
Apr. 2, 2024 (CN) 202410397345.9

(51) Int. Cl. H04W 36/00; H04W 72/23

(52) U.S. Cl. CPC H04W 36/0077; H04W 72/23

(57) ABSTRACT

The disclosure relates to a 5G or 6G communication system for supporting a higher data transmission rate. The disclosure provides methods performed by a distributed unit (DU) in a wireless communication system, the method comprising: receiving, from a central unit (CU), a first message including configuration information for a candidate cell; receiving, from the CU, a second message including timing advance (TA) information for the candidate cell, wherein the TA information includes a TA value and a TA group (TAG) identifier (ID) pointer indicating that a transmission configuration indicator (TCI) state is associated with a first TAG or a second TAG; and transmitting, to a user equipment (UE), a medium access control (MAC) control element (CE) including the TA value and a TCI state ID of the TCI state, wherein the TA value is for the first TAG or the second TAG based on which the TCI state is associated according to the TAG ID pointer.

### CROSS-REFERENCE TO RELATED APPLICATION

This application is based on and claims priority under 35 U.S.C. § 119 to Chinese patent application No. 202410397345.9 filed on Apr. 2, 2024, in the Chinese intellectual property office, the disclosure of which is incorporated by reference herein in its entirety.

### BACKGROUND

### 1. Field

The application relates to the field of wireless communication, and more specifically relates to methods performed by network node and node, as well as the network node and node.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### SUMMARY

In the mobile network, user equipment may switch between different cells. The main problem caused by handover is that user equipment may lose communication during this process. The main reason for the interruption is that the user equipment needs to measure for a long time. Before the handover, the network side needs to conduct signaling interaction between different nodes to determine the target cell and the configuration of the target cell, and then send a handover command to the user equipment. After that, the user equipment needs to synchronize uplink and downlink with the network. In this process, it takes a long time for the user equipment to change cells, which further affects the performance of the user equipment during the mobile process.

According to an aspect of the present disclosure, there is provided a method performed by a first network node in a wireless communication system, which may include receiving a third message from a third network node, the third message may include identification information of a transmission control indication TCI state and information for indicating a timing advance TA group associated with the TCI state; receiving a first message, wherein the first message may include information related to a timing advance TA and information associated with TA information, and the information associated with TA information may include information for indicating the TA group associated with the TCI state; and transmitting a second message to a first node based on the third message and the first message, wherein the second message may include the identification information of the TCI state and first TA information, wherein the first TA information is used for the first node to access a cell, wherein the cell is configured with two or more TA groups or a second TA group.

In some embodiments, in the method performed by the first network node, the information related to the TA may include at least one of the following information: identification information of a cell, identification information of a distributed unit, TA information, and indication information of valid time; and wherein the information associated with TA information may also include at least one of the following information: identification information of a TA group, identification information of the TCI state, first resource indication information for indicating a control resource, signal index information, and second resource indication information for indicating a resource used for transmitting a uplink signal.

In some embodiments, in the method performed by the first network node, the third message may further include at least one of the following information: identification information of a TA group, associated first resource indication information, associated signal index information, and associated second resource indication information.

In some embodiments, in the method performed by the first network node, information included in the third message is received from a second network node via the third network node; wherein information included in the first message is received from a second network node or is received from a second network node via the third network node.

In some embodiments, in the method performed by the first network node, information included in the third message or information included in the first message is information from a second network node received from a fourth network node via the third network node.

In some embodiments, in the method performed by the first network node, the second message may further include at least one of the following information: indication information of a cell and indication information related to random access.

According to another aspect of the present disclosure, there is provided a method performed by a second network node in a wireless communication system, which may include transmitting a first message to a first network node, the first message may include information related to a timing advance TA and information associated with TA information, the information associated with TA information may include information for indicating a TA group associated with a transmission control indication TCI state, based on the first message and a third message, a second message is sent from the first network node to a first node, the second message may include first TA information and identification information of the TCI state, wherein the first TA information is used for the first node to access a cell, and the third message is sent from a third network node to the first network node, the third message may include the identification information of the TCI state and information for indicating the TA group associated with TCI state, wherein the cell is configured with two or more TA groups or a second TA group.

In some embodiments, in the method performed by the second network node, the information related to the TA may include at least one of the following information: identification information of a cell, identification information of a distributed unit, TA information, and indication information of valid time; wherein the information associated with TA information may also include at least one of the following information: identification information of a TA group, the identification information of the TCI state, first resource indication information for indicating a control resource, signal index information, and second resource indication information for indicating a resource used for transmitting a uplink signal.

In some embodiments, in the method performed by the second network node, the third message may further include at least one of the following information: identification information of a TA group, associated first resource indication information, associated signal index information, and associated second resource indication information.

In some embodiments, the method performed by the second network node may further include transmitting information included in the third message to the third network node or a fourth network node.

In some embodiments, the method performed by the second network node may further include transmitting information included in the first message to the third network node or transmitting the information included in the first message to the third network node via a fourth network node.

In some embodiments, in the method performed by the second network node, the second message may further include at least one of the following information: indication information of a cell and indication information related to random access.

According to another aspect of the present disclosure, there is provided a method performed by a third network node in a wireless communication system, the method may include transmitting a third message to a first network node, the third message may include identification information of a transmission control indication TCI state and information for indicating a timing advance TA group associated with the TCI state, and based on the third message and a first message, a second message is sent by the first network node to a first node, the second message may include the identification information of the TCI state and first TA information, wherein the first TA information is used for the first node to access a cell, wherein the cell is configured with two or more TA groups or a second TA group, wherein the first message is received by the first network node, and the first message may include information related to a TA and information associated with TA information, which includes information for indicating a TA group associated with the TCI state.

In some embodiments, in the method performed by the third network node, the information related to the TA may include at least one of the following information: identification information of a cell, identification information of a distributed unit, TA information, and indication information of valid time; wherein the information associated with TA information may also include at least one of the following information: identification information of a TA group, the identification information of the TCI state, first resource indication information for indicating a control resource, signal index information, and second resource indication information for indicating a resource used for transmitting a uplink signal.

In some embodiments, in the method performed by the third network node, the third message may further include at least one of the following information: identification information of a TA group, associated first resource indication information, associated signal index information, and associated second resource indication information.

In some embodiments, in the method performed by the third network node, information included in the third message is received from a second network node; the method may further include receiving information included in the first message from the second network node.

In some embodiments, in the method performed by the third network node, the information included in the third message is received from a second network node via a fourth network node; the method may further include receiving information included in the first message from the fourth network node.

In some embodiments, in the method performed by the third network node, the second message may further include at least one of the following information: indication information of a cell and indication information related to random access.

According to another aspect of the present disclosure, there is provided a method performed by a first node in a wireless communication system, which may include receiving a second message from a first network node, wherein the second message may include identification information of a transmission control indication TCI state and first timing advance TA information, wherein the first TA information is used for the first node to access a cell; and accessing a cell using TA information, wherein the cell is configured with two or more TA groups or a second TA group, wherein the second message is determined based on a first message received by the first network node and a third message received by the first network node from a third network node, wherein the first message may include information related to a TA and information associated with TA information, wherein the information associated with TA information may include information for indicating a TA group associated with the TCI state, wherein the third message may include the identification information of the TCI state and information for indicating the TA group associated with the TCI state.

In some embodiments, in the method performed by the first node, the information related to the TA may include at least one of the following information: identification information of a cell, identification information of a distributed unit, TA information, and indication information of valid time; wherein the information associated with TA information may also include at least one of the following information: identification information of a TA group, the identification information of the TCI state, first resource indication information for indicating a control resource, signal index information, and second resource indication information for indicating a resource used for transmitting a uplink signal.

In some embodiments, in the method performed by the first node, the third message may further include at least one of the following information: identification information of a TA group, associated first resource indication information, associated signal index information, and associated second resource indication information.

In some embodiments, in the method performed by the first node, the second message may further include at least one of the following information: indication information of a cell and indication information related to random access.

According to another aspect of the present disclosure, there is provided a first network node or a second network node or a third network node or a first node in a wireless communication system, which may include a transceiver for transmitting and receiving a signal; and a controller coupled with the transceiver and configured to perform a corresponding method as performed by the first network node or the second network node or the third network node or the first node.

According to another aspect of the present disclosure, there is provided an electronic device, including a memory for storing a computer program; and a controller configured to execute the computer program to implement the method of the present disclosure. The electronic device can be a node or a user equipment.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary system architecture for SAE according to an example embodiment of the present disclosure.

FIG. 2 illustrates an exemplary system architecture according to various embodiments of the present disclosure;

FIG. 3 illustrates a flowchart of a first example interaction between network nodes and a user equipment according to an example embodiment of the present disclosure;

FIG. 4 illustrates a flowchart of a second example interaction between network nodes and a user equipment according to an example embodiment of the present disclosure;

FIG. 5 illustrates a flowchart of a third example interaction between network nodes and a user equipment according to an example embodiment of the present disclosure;

FIG. 6 illustrates a flowchart of a fourth example interaction between network nodes and a user equipment according to an example embodiment of the present disclosure;

FIG. 7 illustrates a node according to an example embodiment of the present disclosure;

FIG. 8 illustrates a user equipment according to an example embodiment of the present disclosure;

FIG. 9 illustrates a structure of a UE according to an embodiment of the present disclosure; and

FIG. 10 illustrates a structure of a network node according to an embodiment of the present disclosure.

### DETAILED DESCRIPTION

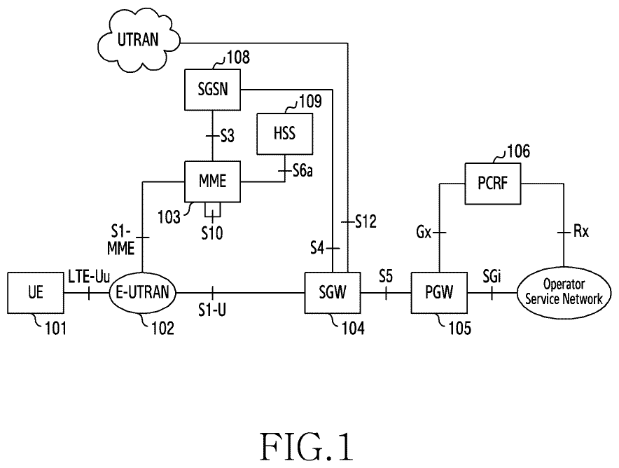

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to facilitate a comprehensive understanding of various embodiments of the present disclosure defined by the claims and their equivalents. This description includes various specific details to facilitate understanding but should only be considered as exemplary. Accordingly, those skilled in the art will recognize that various changes and modifications can be made to the various embodiments described herein without departing from the scope of this disclosure. In addition, for the sake of clarity and conciseness, descriptions of well-known functions and structures may be omitted.

The terms and expressions used in the following specification and claims are not limited to their dictionary meanings, but are only used by the inventors to enable a clear and consistent understanding of the present disclosure. Therefore, it should be obvious to those skilled in the art that the following descriptions of various embodiments of the present disclosure are provided for illustration purposes only and are not intended to limit the purposes of the present disclosure as defined in the appended claims and their equivalents.

It should be understood that singular forms of “a,” “an” and “the” include plural referents unless the context clearly indicates otherwise. Thus, for example, a reference to a “component surface” includes a reference to one or more such surfaces.

The terms “include” or “may include” refer to the existence of a corresponding disclosed function, operation or component that can be used in various embodiments of the present disclosure, and do not limit the existence of one or more additional functions, operations, or features. In addition, the terms “including” or “having” can be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the present disclosure includes any of the listed terms and all combinations thereof. For example, “A or B” may include a, may include B, or may include both A and B.

Unless defined differently, all terms (including technical terms or scientific terms) used in this disclosure have the same meaning as those understood by those skilled in the art in this disclosure. Common terms, as defined in dictionaries, are interpreted as having meanings consistent with the context in the relevant technical fields, and should not be interpreted in an idealized or overly formal way unless explicitly defined in this disclosure.

The drawings discussed below and various embodiments used to describe the principles of the disclosure in this patent document are for illustration only and should not be construed as limiting the scope of the disclosure in any way. Those skilled in the art will understand that the principles of the present disclosure can be implemented in any suitably arranged system or device.

FIG. 1 illustrates an exemplary system architecture 100 of system architecture evolution (SAE) according to an example embodiment of the present disclosure. User equipment (UE) 101 is a terminal device for receiving data. Evolved universal terrestrial radio access network (E-UTRAN) 102 is a radio access network, which includes base station (eNodeB/Node B) which provides an interface for UE to access the radio network. The mobility management entity (MME) 103 is responsible for managing the mobility context, session context and security information of the UE. The serving gateway (SGW) 104 mainly provides the function of the user plane, and the MME 103 and SGW 104 may be in the same physical entity. The packet data network gateway (PGW) 105 is responsible for accounting, lawful interception, and other functions, and may also be in the same physical entity as the SGW 104. A policy and charging rules function (PCRF) 106 provides quality of service (QoS) policies and charging criteria. The general packet radio service support node (SGSN) 108 is a network node device that provides a route for data transmission in universal mobile telecommunications system (UMTS). Home subscriber server (HSS) 109 is the home attribution subsystem of the UE, and is responsible for protecting user information including the current location of the user equipment, the address of the service node, user security information, packet data context of the user equipment, etc.

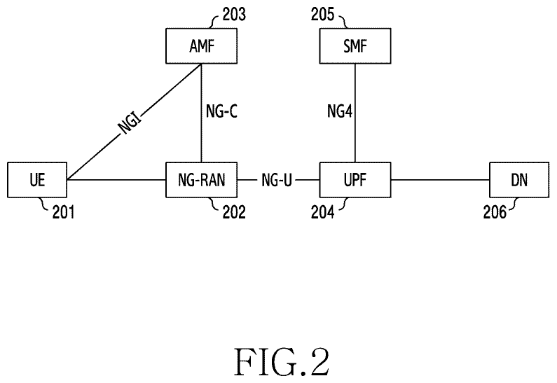

FIG. 2 illustrates an exemplary system architecture 200 according to various embodiments of the present disclosure. Other embodiments of the system architecture 200 can be used without departing from the scope of this disclosure.

User equipment (UE) 201 is a terminal device for receiving data. The next generation radio access network (NG-RAN) 202 is a radio access network, which includes a base station (gNB or an eNB connected to the 5GC of the 5G core network, and the eNB connected to the 5GC is also called ng-gNB) that provides an interface for UE to access the radio network. The access control and mobility management function (AMF) 203 is responsible for managing the mobility context and security information of the UE. The user plane function entity (UPF) 204 mainly provides the functions of the user plane. The session management functional entity SMF 205 is responsible for session management. The data network (DN) 206 includes services of operators, Internet access and services of third parties.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is obvious to those skilled in the art that changes can be made to the illustrated embodiments and examples without departing from the scope of this disclosure.

Before introducing specific contents, some assumptions and some definitions of this disclosure are given below.
The message names in this disclosure are just examples, and other message names can also be used.
The words “first” and “second” and the like contained in the message names of this disclosure are only used to distinguish one message from another, and do not represent the execution or transmission order.
A detailed description of steps irrelevant to this disclosure is omitted in this disclosure.
In the present disclosure, steps in each flow can be combined with each other and performed or performed independently. The execution steps of each flow are only examples, and other possible execution steps and/or orders are not excluded.
In this disclosure, the base station may be a 6G base station, a 5G base station (such as a gNB and a ng-eNB), a 4G base station (such as an eNB), or other types of access nodes.
In this disclosure, when the cell accessed by the user equipment changes from one cell to another, this behaviour can be called handover or Cell switch. In the following description, handover and cell switch have the same meaning and can be used interchangeably.
In this disclosure, users, user equipment, user terminals and user terminal equipment are equivalent.
In this disclosure, the terms “associated with” and “corresponding to” can be used interchangeably. For example, “A is associated with B” and “A is corresponding to B” indicate that there is an association and/or correspondence between A and B.
In the present disclosure, synchronization information may include at least one of:
   Downlink synchronization information; and/or
   Uplink synchronization information, such as timing advance information.

The nodes involved in this disclosure include:
A first node: a user equipment, which can be a mobile phone or a relay node;
A second node: a node serving a source cell, which may be a base station, or a central unit (CU) of the base station, or a control plane portion of the central unit of the base station;
A third node: a distributed unit (DU) of the base station serving the source cell;
A fourth node: a node serving a target cell or a candidate cell, which may be a base station, or a central unit of the base station, or a control plane portion of the central unit of the base station; and/or
A fifth node: a distributed unit of the base station serving the target cell or the candidate cell.

In one example, the fourth node and the second node may be the same node. If the base station is in a distributed structure, the third node and the fifth node are both distributed units controlled by the second node. In another example, the fourth node and the second node may be different nodes.

In one example, the source cell or target cell or candidate cell may a special cell (SpCell), such as a SpCell of a master cell group or a primary cell (PCell), or a special cell of a secondary cell group or a primary secondary cell (PSCell).

The base stations involved in the above-mentioned second to fifth nodes can be one of the following types (other types that can be used for a user terminal to access are not excluded):
A long term evolution (LTE) base station;
A 5G base station;
A 6G base station;
A radio access network (RAN) node;
A non-terrestrial network (NTN) base station;
A high altitude platform station (HAPS) base station;
A drone base station; and/or
A WIFI access point.

In moving process of a user equipment, cell switch is inevitable, but communication interruption during cell switch may affect data transmission of the user equipment. In order to overcome this problem, layer 1 and layer 2 triggered mobility (LTM) mechanism is introduced into the mobile system. In this mechanism, the user equipment can obtain the Timing advance information of the uplink signal needed to access the target cell or the candidate cell from a handover command from the source cell, so that at least part of the access process can be omitted when the user equipment accesses the target cell, and the communication interruption when the user equipment accesses the target cell is reduced. However, when the target cell or candidate cell being accessed is configured with multiple input multiple output (MIMO), a cell may be served by different transmission-receiving points (TRPs) (a component of the base station). In this scenario, how to switch between cells is an urgent problem to be solved.

After a network entity (and/or network device and/or network node) serving the target cell or candidate cell obtains the TA information of the user equipment, the user equipment may send the TA information and indication information for distinguishing the TA information to a network entity serving the source cell of the user equipment, and then the network entity serving the source cell can determine the TA information to be sent to the user equipment according to the information and the pre-configured information, and send the determined TA information to the user equipment. After receiving the TA information, the user equipment can also use the TA information correctly. In this disclosure, the cell serving the user equipment before handover is the source cell, and the cell where the user equipment is located after handover (or the cell serving the user equipment) is the target cell or the candidate cell. The target cell or candidate cell is configured with two TA groups or a second TA group (when the second TA group is configured, it means that this cell is configured with two TA groups).

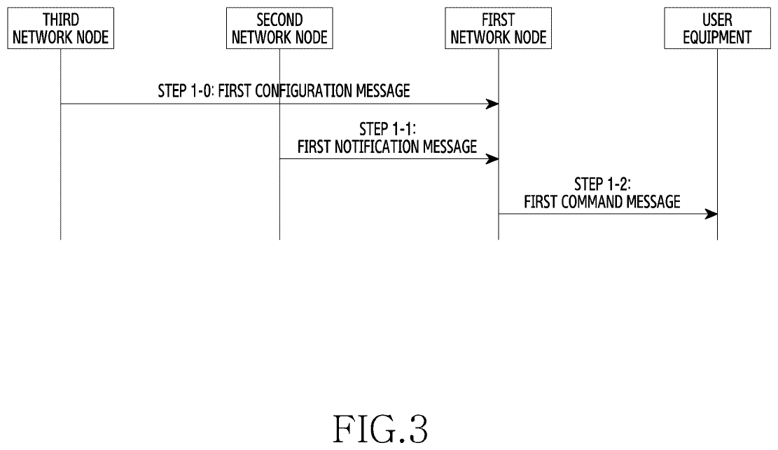

TA information acquisition process (as shown in FIG. 3):

Step 1-1: A second network node sends a first message to a first network node. In one example, the first message may be a first notification message, but it is not limited thereto. The main function of this message is to provide timing advance information required for a user equipment to access a target cell or a candidate cell. For example, the first network node may receive the first notification message from the second network node to acquire the following “information related to timing advance TA” and “information associated with TA information” used by the user equipment to access the cell. The message has the beneficial effects of helping the source cell serving the user equipment to obtain the timing advance information for the user equipment to access the target cell or the candidate cell, thereby providing the information for the user equipment and reducing communication interruption when the user equipment accesses the target cell or the candidate cell. The message may include one or more timing advance information, and for one timing advance information, the message may include at least one of the following information:
Information related to timing advance, which indicates information related to timing advance required for user equipment to access a cell, which may be a target cell or a candidate cell, and the information may include at least one of the following information:
   Identification information of a cell, which indicates a cell to which the “information related to timing advance” applies;
   Identification information of a distributed unit of a base station, which indicates identification information of a distributed unit of a base station to which the “information related to timing advance” applies;
   Timing advance information, which indicates a value of a timing advance, and the user equipment can transmit according to the value indicated by the information when transmitting the uplink signal; and/or
   Indicating information of valid time, which indicates valid time of the “timing advance information,” during which the “timing advance information” can be used by the user equipment for transmitting uplink signals, and if time indicated by the information expires, the “timing advance information” cannot be used by the user equipment for transmitting uplink signals; and/or
Information associated with timing advance information, which indicates a TAG (TA Group) or a TCI (Transmission Control Indicator, and/or Transmission Configuration Indicator) state associated with the “information related to timing advance.” If a cell is configured with two or more different TAGs or a second TAG, indicating that the cell supports more than one TAG, the information can implicitly or explicitly indicate a TAG associated with the above “information related to timing advance.” In one example, the information may indicate a TAG associated with the above “information related to timing advance,” and in another example, the information may indicate a TCI state associated with the above “information related to timing advance,” and the associated TCI state corresponds to a TAG. The information has the beneficial effects of helping the first network node to determine the TAG or TCI state corresponding to the received “information related to timing advance,” which can facilitate the transmission of correct TA information to the user equipment and ensure that the user equipment can successfully access the target cell or the candidate cell. The information may include at least one of the following information:
   Indicating information of a TA group, which indicates a TAG associated with the above “information related to timing advance.” In one example, the information may be information for indicating a TAG associated with a TCI state. In one example, this information is the following “identification information of TA group”; in another example, the information is used to indicate an identification of the TAG, that is, the information itself is not an identification information, but the first network node can obtain the identification information of the TAG according to the information; in another example, the information is used to indicate associated TCI states, and each associated TCI state corresponds to a TAG. For example, the information can be “tag-id-ptr” (in one example, the information can be named as a pointer of TAG identification information, i.e., a TAG ID pointer), and in one example, the information can be information used to indicate the TAG associated with TCI state. Before receiving the first notification message, such as through the following Step 1-0, the first network node may be configured with identification information of different TCI states, and the identification information of each TCI state has corresponding “tag-id-ptr” information, which is used to indicate the TAG associated with the TCI state. If the value of the information is a first value (such as n0), the TAG associated with the TCI state is the TAG indicated by the first TAG identifier (such as a tag-id), and if the value of the information is a second value (such as n1), the TAG associated with the TCI state is the TAG indicated by the second TAG identifier; and so on. Therefore, when the first network node receives the “tag-id-ptr” through the first notification message, it can determine the TAG associated with the received “information related to timing advance” according to the information, and can also obtain the TCI state associated with the “information related to timing advance,” thus helping the first network node to send the first command message to the user equipment (Step 1-2 below);
   Identification information of a TA group, which indicates identification information of a TAG associated with the “information related to timing advance.” After receiving this information, the first network node may determine the TAG or a TCI state to which the received TA information belongs according to this information;
   Identification information of the TCI state, which indicates a TCI state. In one example, this information may be a TCI state of an uplink signal (such as a preamble) transmitted by user equipment, a TCI state of a downlink signal, or a TCI state of an uplink signal transmitted by user equipment and/or a downlink signal. In another example, this information can be used to indicate a TCI state associated with the above-mentioned “information related to timing advance,” and in turn a TAG associated with this TCI state and identification information of other TCI states associated with this TAG can be determined. In one embodiment, before receiving the first notification message, the first network node may be pre-configured with identification information of different TCI states through the following Step 1-0 (in one example, the identification information of the TCI states identifies candidate TCI states used by the user to access a target cell or a candidate cell), and the identification information of each TCI state has corresponding “tag-id-ptr” information. The information is used to indicate a TAG associated with the TCI state. If a value of the information is a first value (such as n0), the TAG associated with the TCI state is a TAG indicated by a first TAG identifier (such as a tag-id). If the value of the information is a second value (such as n1), the TAG associated with the TCI state is a TAG indicated by a second TAG identifier, and so on. When the first network node receives the first notification message, it may determine the “tag-id-ptr” information corresponding to the TCI state according to the contained “identification information of the TCI state,” and determine the TAG corresponding to the “identification information of the TCI state” according to this information and determine other TCI states corresponding to the same TAG corresponding to the “identification information of the TCI state” according to this information, so as to help the first network node to include correct TA information according to the TCI state when transmitting the following first command message. In another embodiment, before receiving the above-mentioned first notification message, such as through the following Step 1-0, the first network node may be pre-configured with two or more lists of TCI state information, and each list of TCI state information contains identification information of at least one TCI state (in one example, the identification information of TCI state identifies the candidate TCI state used by the user to access the target cell or candidate cell). The TCI states identified by the identification information of the TCI state in the same list of TCI state information correspond to the same TAG. When the first network node receives the first notification message, it may determine other TCI states corresponding to the same TAG corresponding to the TCI state according to the “identification information of the TCI state,” so as to help the first network node to contain correct TA information according to the TCI states when sending the following first command message;
   First resource indication information, which indicates index information of control resources, such as a control resource set (CORESET) index, which indicates control resources associated with the “information related to timing advance,” and further can be used to indicate its associated TAG or TCI state, so the TAG or TCI state associated with the “information related to timing advance” can be obtained according to this information. In an example, before receiving the first notification message, such as through the following Step 1-0, the first network node may be pre-configured with different control resources, and identification information of one or more TCI states corresponding to the control resources and/or information of a TAG corresponding to the control resources. After receiving the first notification message, the first network node may know the TAG or the identification information of TCI state associated with the “information related to timing advance” according to the “first resource indication information,” so as to help the first network node to contain the correct TA information according to the TCI state when sending the following first command message;
   Signal index information, which indicates an index of an uplink signal transmitted by the user equipment. In one example, the uplink signal is a Preamble in a random access procedure, so the information is an index of the Preamble. In another example, when different preamble index corresponds to different TAGs or different TCI states, the information can also implicitly indicate the TAGs or TCI states associated with the above “information related to timing advance.” In one embodiment, before receiving the first notification message, such as through the following Step 1-0, the first network node may be pre-configured with different signal index information and TAGs and/or identification information of TCI states corresponding to the signal index information. After receiving the first notification message, the first network node may know the TAG or the identification information of TCI state associated with the “information related to timing advance” according to the “signal index information,” so as to help the first network node to include the correct TA information according to the TCI state when sending the following first command message; and/or
   Second resource indication information, which indicates a resource used by the UE to send an uplink signal (such as a preamble). In one example, this information may be a Random Access-Radio Network Temporary Identifier (a RA-RNTI). In another example, when different resources correspond to different TAGs or different TCI states, the information can also implicitly indicate the TAG or TCI state associated with the above “information related to timing advance.” In one embodiment, before receiving the first notification message, such as through the following step 1-0, the first network node may be pre-configured with different second resource indication information and TAG and/or identification information of TCI state corresponding to the second resource indication information. After receiving the first notification message, the first network node may know the TAG or identification information of TCI state associated with the “information related to timing advance” according to the “second resource indication information,” so as to help the first network node to include the correct TA information according to the TCI state when sending the following first command message.

### Transmitting Process of TA Information (as Shown in FIG. 3):

Step 1-2: The first network node sends a second message to a user equipment (a first node). In one example, the second message may be a first command message, but it is not limited thereto. The main function of this message is to inform the user equipment to perform handover or cell switch, and provide information required for handover or cell switch. For example, the first command message can be used to indicate TA information used by the user equipment when accessing the cell. The message has the beneficial effects of providing information required by the user equipment for handover or cell switch, and reducing interruption of data transmission of the user equipment. The message may include at least one of the following information:
Indication information of a cell, which is used to indicate an identification of a target cell or candidate cell, or configuration corresponding to the target cell or candidate cell, such as a configuration ID;
Timing advance information, which indicates a TA used to access the target cell or candidate cell;
Identification information of the TCI state, which indicates a TCI state used to access the target cell or candidate cell. In one example, the information indicates a downlink TCI state, in another example, the information indicates an uplink TCI state, in another example, the information indicates uplink and downlink TCI states, and in another example, the information may contain two identification information, one indicates a downlink TCI state and the other indicates an uplink TCI state. In one embodiment, the user equipment can determine a TAG associated with the “timing advance information” according to the information. Specifically, before receiving the first command message, the network side may configure the user equipment in advance. In this configuration, for a target cell or a candidate cell, the user equipment is configured with one or more different TCI states, and each TCI state is configured with a “tag-id-ptr” (a TAG ID pointer), which indicates a TAG associated with the TCI state. For example, if the “tag-id-ptr” is a first value (such as n0), it is indicated that the TAG corresponding to the TCI state is a TAG identified by a first TAG identification information (a tag-id) indicated when configuring the cell. If the “tag-id-ptr” is a second value (such as n1), it is indicated that the TAG corresponding to the TCI state is a TAG identified by a second TAG identification information (a tag2-id) indicated when configuring the cell, and so on. When the user equipment receives the “identification information of the TCI state,” if the TCI state indicated by the “identification information of the TCI state” is pre-configured with “tag-id-ptr” and if the “tag-id-ptr” is set to a first value (such as n0), the TAG corresponding to the “timing advance information” is a TAG identified by a first TAG identification information (a tag-id) of the target cell or candidate cell. If the “tag-id-ptr” is set to a second value (such as n1), the TAG corresponding to the “timing advance information” is a TAG identified by a second TAG identification information (a tag2-id) of the target cell or the candidate cell, and so on. This method has the beneficial effects that the user equipment can implicitly know the TAG corresponding to the received “timing advance information” according to the received identification information of the TCI state, thus reducing the signaling overhead and ensuring correct use of TA information by the user equipment; and/or
Indicating information related to random access, which indicates configuration information required by the user equipment for random access when accessing the target cell or the candidate cell, and this information may include at least one of the following information:
   Signal index information, such as a Preamble index;
   Index information of a synchronization signal, such as a synchronization signal block SSB/physical broadcast channel PBCH index;
   Indication information of a resource of a random access signal, which indicates the resource used by the user equipment to send the random access signal, such as a physical random access channel (PRACH) mask index, which indicates an occasion of the RACH; and/or
   Indicating information of the number of repetitions, which indicates the number of repetitions when the user equipment transmits Message 1 (Msg1, such as a preamble) in random access procedure.

The first command message may be an LTM cell switch medium access control (MAC) control element (CE) or other types of messages.

### Configuration Process of Network Nodes (as Shown in FIG. 3):

Before Step 1-1, a configuration process for the first network node may also be included, namely:

Step 1-0: A third network entity or a third network node transmits a third message to the first network node. In one example, the third message may be a first configuration message, but it is not limited thereto. For example, the first configuration message can be used to configure a TA group associated with a TCI state. The main function of this message is to provide configuration information required for a user equipment to access a target cell or candidate cell. This configuration information can help the first network node to trigger the user equipment to perform cell handover, and provide the user equipment with information for accelerating handover, such as TA information, indication information of a TCI state, etc. After receiving the first configuration message, the user equipment may use the TA information therein to access the cell. For a target cell or a candidate cell, the message may include at least one of the following information:
Cell identification information, which indicates a target cell or a candidate cell;
Configuration identification information, which indicates a configuration of the target cell or the candidate cell;
TAG-related information, which indicates tag-related information of the target cell or candidate cell. In one example, when a target cell or a candidate cell is configured with two or more TAGs, the information indicates information associated with each TAG. According to this information, the first network node can determine a TAG or TCI state corresponding to the subsequently received TA information (such as “information related to timing advance” received through the above step 1-1). The information has the beneficial effects that correspondence between the TCI state and TAG is configured, which helps the first network node to determine the TAG corresponding to the TA information after receiving the TA information, so as to configure correct TA information for the user equipment. For a TAG, the information may include at least one of the following information:
Identification information of a TAG, which indicates a TAG;
Information related to a TCI state, which provides information of a TCI state associated with a TAG, that is, information of TA group related to the TCI state, which may include information of one or more TCI states. When the target cell or candidate cell has two or more TAGs, each TAG has one piece of the “information related to a TCI state.” In one example, the TCI state is a candidate TCI state used by a user to access the target cell or candidate cell. For a TCI state, the information may include at least one of the following information:
   Identification information of the TCI state;
   Identification information of a TAG, which indicates a TAG;
   Indication information of an associated TAG, which indicates a TAG associated with the TCI state indicated by the above “identification information of the TCI state.” That is, the indication information of the associated TAG is used to indicate a TAG associated with the TCI state. In one example, the information is “tag-id-ptr” information (in one example, the information can be named as a pointer of TAG identification information, that is, a TAG ID pointer). If a value of the information is a first value (such as n0), the TAG associated with the TCI state indicated by the above “identification information of the TCI state” is a TAG indicated by a first TAG identification (such as a tag-id). If the value of the information is a second value (e.g., n1), the TAG associated with the TCI state indicated by the “identification information of the TCI state” is a TAG indicated by the second TAG identifier (e.g., a tag2-id);
   Associated first resource indication information, which indicates index information of a control resource corresponding to the “identification information of the TCI state,” such as a CORESET (a control resource set) index. In the subsequent received TA information (as obtained in the above step 1-1), the first network node can know a TAG corresponding to the TA information according to the “first resource indication information” corresponding to the received TA information, and know the TCI state corresponding to the received TA information according to the “identification information of the TCI state” and “associated first resource indication information” contained in the above “information related to a TCI state”;
   Associated signal index information, which indicates an index of a signal corresponding to the above-mentioned “identification information of the TCI state.” In one example, the signal may be a preamble sent by the user equipment. Because each TCI state corresponds to a TAG, this information indicates that the user equipment transmits different preambles when acquiring the TA information of different TAGs. In this way, in the subsequent received TA information (as obtained in the above step 1-1), the first network node can know the TAG corresponding to the TA information according to the signal index information corresponding to the received TA information, and know the TCI state corresponding to the received TA information according to the “identification information of the TCI state” and “associated signal index information” contained in the above “information related to a TCI state”; and/or
   Associated second resource indication information, which indicates a resource used by the user equipment to transmit an uplink signal corresponding to the above “identification information of the TCI state.” In the subsequent received TA information (as obtained in the above step 1-1), the first network node can know the TAG corresponding to the TA information according to the “second resource indication information” corresponding to the received TA information, and know the TCI state corresponding to the received TA information according to the “identification information of the TCI state” and “associated second resource indication information” contained in the above “information related to a TCI state”; and/or
Configuration information related to random access, which provides configuration information required by the user equipment performing a random access when accessing the target cell or the candidate cell. In one example, this information can help the first network node to determine the resource used by the user equipment for random access, and transmit the information to the user equipment through the first command message. The information may include at least one of the following information:
   General configuration information of random access, such as a RACH-ConfigGeneric, which may include at least one of the following information: prach-configurationIndex, a target power of a preamble received by the network receiver side (preambleReceivedTargetPower), the maximum number of times to transmit a preamble (Preamble TransMax), an increase step of the transmission power of Preamble (powerRampingStep), a size of a random access response window (ra-ResponseWindow), etc.;
   Dedicated configuration information of random access, such as RACH-ConfigDedicated, which may include at least one of the following information: configuration information related to contention-free random access, occasion information, rach-ConfigGeneric, the number of SSBs corresponding to each RACH occasion is ssb-perRACH-occassion, configuration information of resources (such as a mask index for random access resource selection, a physical random access channel mask index), an index of a corresponding SSB or a channel state information reference signal (SSB/CSI/RS-index), and an index of a preamble (ra-Preamblelndex); and/or
   Indicating information of a number of repetitions of message 1, which indicates the number of repetitions of message 1 (preamble) transmitted by the user equipment in random access procedure. After receiving this information, the first network node may determine the indication information of the number of repetitions contained in the first command message according to this information.

The first notification message may be a TA information transfer message (a DU-CU TA information transfer message) from the distributed unit of the base station to the central unit of the base station on a F1 interface (an interface between the central unit of the base station and the distributed unit of the base station), a TA information transfer message (a CU-DU TA information transfer message) from the central unit of the base station to the distributed unit of the base station, a TA information transfer message from the base station to the base station, or other types of messages.

The first command message may be an LTM cell switch MAC CE or other types of messages.

The first configuration message may be a UE context setup/modification request message on the F1 interface, a handover request acknowledge message between base stations, or other types of messages.

In order to explain that the first network node determines the TCI state or TAG corresponding to the received TA information, the following are different methods based on the above process:
Method 1: Determine the TCI state or TAG corresponding to TA information according to tag-id-ptr (pointer information identified by a TAG).

In this method, the first network node is pre-configured with the tag-id-ptr corresponding to the TCI states, and then the first network node may receive the TA information and the tag-id-ptr information from the second network node, so that one or more TCI states corresponding to the TA information can be determined, so that when transmitting a handover command to the user equipment, the TA information corresponding to the TCI states is provided according to the identification information of the TCI states in the command. Specifically, it includes the following steps:

Step a1-0: The third network entity or the third network node transmits a first configuration message to the first network node, which may include the following information (for other information contained in this message, please refer to the description in the Step 1-0 above):
Information related to a TCI state, which reflects a mapping relation (or an association relation) between TCI states and TAG. For each TCI state, the information may include at least one of the following information (for the description of each information contained in the information, please refer to the description in the Step 1-0 above):
   Identification information of the TCI state; and/or
   (optional) indication information of an associated TAG, such as a tag-id-ptr, which indicates the TAG corresponding to the TCI state identified by the above “identification information of the TCI state.”

Step a1-1: The second network node transmits to the first network node the first notification message, which may include the following information:
Information related to timing advance (for the information contained in this information, please refer to the description in Step 1-1 above); and/or
Information associated with timing advance information, which may include at least one of the following information:
   Indicating information of a TA group, such as the information is “tag-id-ptr” (please refer to the description in Step 1-1 above for details); and/or
   Identification information of the TCI state, which indicates the TCI state associated with the above “information related to timing advance.” After receiving this information, the first network node may determine that the “information related to timing advance” is also applicable to the “other TCI states” (i.e., other TCI states having the same “indication information of an associated TAG” as the “identification information of the TCI state”) according to other TCI states which have the same “indication information of an associated TAG” as the “identification information of the TCI state” contained in the “information related to a TCI state” obtained in the step a1-0.

Step a1-2: The first network node transmits the first command message to the user equipment, which may include the following information (for a detailed description of the information contained in this message, please refer to the description in Step 1-2 above):
Indication information of a cell;
Timing advance information; and/or
Identification information of the TCI state, and the “timing advance information” corresponding to this information is determined by the first network node according to the information obtained in step a1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in step a1-0 and the TA information received in step a1-1. Specifically, the indication information of the TAG corresponding to each TCI state is configured in the step a1-0, while step a1-1 contains the indication information of the TAG corresponding to the TA information, then the first network node may determine the TA information corresponding to the “identification information of the TCI state” in step a1-2.
Method 2: Determine the TCI state or TAG corresponding to TA information according to a tag-id (a TAG identification).

In this method, the first network node is pre-configured with the tag-id corresponding to the TCI state, and then the first network node may receive the TA information and the tag-id information from the second network node, and then one or more TCI states corresponding to the TA information can be determined, so that when transmitting a handover command to the user equipment, the TA information corresponding to the TCI state is provided according to the identification information of the TCI state in the command. Specifically, it includes the following steps:

Step b1-0: The third network entity or the third network node transmits to the first network node the first configuration message, which may include the following information (for other information contained in this message, please refer to the description in Step 1-0 above): Information related to a TCI state, which reflects the mapping relation or association relation between TCI states and TAG. For each TCI state, the information may include at least one of the following information (for the description of each information contained in the information, please refer to the description in Step 1-0 above): Identification information of the TCI state; and/or Identification information of a TAG.

Step b1-1: The second network node transmits to the first network node the first notification message, which may include the following information:
Information related to timing advance (for the information contained in this information, please refer to the description in Step 1-1 above); and/or
Information associated with timing advance information, which may include the following information:
   Identification information of a TAG.

Step b1-2: The first network node transmits to the user equipment the first command message, which may include the following information (for detailed description of the information contained in this message, please refer to the description in Step 1-2 above):
Indication information of a cell;
Timing advance information; and
The identification information of the TCI state, and the “timing advance information” corresponding to this information is determined by the first network node according to the information obtained in the step b1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in step b1-0 and the TA information received in step b1-1. Specifically, the identification information of the TAG corresponding to each TCI state is configured in step b1-0, while the step b1-1 contains the identification information of the TAG corresponding to the TA information, the first network node may determine the TA information corresponding to the “identification information of the TCI state” in step b1-2.
Method 3: Determine the TCI state or TAG corresponding to TA information according to TCI state information (such as the identification information of the TCI state).

In this method, the first network node is pre-configured with different TCI state groups (and/or lists), and each group corresponds to one TAG, which contains at least one TCI state. Then the first network node may receive TA information and the identification information of the TCI state from the second network node, and then one or more TCI states corresponding to the TA information can be determined, so that when transmitting the handover command to the user equipment, TA information corresponding to the TCI state can be provided according to the identification information of the TCI state in the command. Specifically, it includes the following steps:

Step c1-0: The third network entity or the third network node transmits to the first network node the first configuration message, which may include the following information (for other information contained in this message, please refer to the description in Step 1-0 above):
Information related to a TCI state, which reflects the mapping relation or association relation between TCI states and TAG. The information may include one or more lists of TCI states, each list includes information of at least one TCI state (such as identification information of the TCI states), and each list corresponds to one TAG, so TCI states in the same list may share the same TA information.

Step c1-1: The second network node transmits to the first network node the first notification message, which may include the following information:
Information related to timing advance (for the information contained in this information, please referred to the description in the Step 1-1 above); and
Information associated with timing advance information, which may include the following information:
   Identification information of the TCI state, which indicates the TCI states associated with the above “information related to timing advance.”

Step c1-2: The first network node transmits to the user equipment the first command message, which may include the following information (for detailed description of the information contained in this message, please refer to the description in the Step 1-2 above):
Indication information of a cell;
Timing advance information; and
Identification information of □the TCI state. The “timing advance information” corresponding to this information is determined by the first network node according to the information obtained in the step c1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in step c1-0 and the TA information received in step c1-1. Specifically, in step c1-0, a plurality of lists of TCI states are configured, and each list corresponds to a TA group. While Step c1-1 contains the identification information of the TCI state and TA information corresponding to this TCI state. After receiving this information, the first network node can determine the TA information corresponding to each TCI state list (because the identification information of TCI state in the same TCI state list corresponds to the same TA information), then the first network node may determine the TA information corresponding to the “identification information of the TCI state” in step c1-2.
Method 4: Determine the TCI states or TAG corresponding to TA information according to the first resource indication information (such as the index information of control resources).

In this method, the first network node is pre-configured with the first resource corresponding to the TCI state (such as the index information of a control resource), and then the first network node may receive the TA information and the first resource indication information from the second network node, so that the TA information corresponding to the TCI state can be determined, so that when transmitting the handover command to the user equipment, the TA information corresponding to the TCI state can be provided according to the identification information of the TCI state in the command. Specifically, it includes the following steps:

Step d1-0: The third network entity or the third network node transmits to the first network node the first configuration message, which may include the following information (for other information contained in this message, please refer to the description in the Step 1-0 above):
Information related to a TCI state, which may include the following information:
   Identification information of the TCI state; and/or
   Associated first resource indication information.

Step d1-1: The second network node transmits to the first network node the first notification message, which may include the following information:
Information related to timing advance (for the information contained in this information, please refer to the description in the Step 1-1 above); and
Information associated with timing advance information, which may include the following information:
   First resource indication information.

Step d1-2: The first network node transmits to the user equipment a first command message, which may include the following information (for detailed description of the information contained in this message, please refer to the description in the Step 1-2 above):
Indication information of a cell;
Timing advance information; and/or
The identification information of the TCI state, and the “timing advance information” corresponding to this information is determined by the first network node according to the information obtained in the step d1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in the step d1-0 and the TA information received in the step d1-1. Specifically, the first resource indication information corresponding to each TCI state is configured in the step d1-0, while the step d1-1 contains the first resource indication information corresponding to the TA information, the first network node may determine the TA information corresponding to the “identification information of the TCI state” in the step d1-2.
Method 5: Determine TCI state or TAG corresponding to the TA information according to signal index information (such as index information of a preamble).

In this method, the first network node is pre-configured with the signal index information corresponding to the TCI state (such as the index information of a preamble), and then the first network node may receive the TA information and the signal index information from the second network node, so that the TA information corresponding to the TCI state can be determined, so that when transmitting the handover command to the user equipment, the TA information corresponding to the TCI state can be provided according to the identification information of the TCI state in the command. Specifically, it includes the following steps:

Step e1-0: The third network entity or the third network node transmits to the first network node the first configuration message, which may include the following information (for other information contained in this message, please refer to the description in the Step 1-0 above):
Information related to a TCI state, which may include the following information:
   Identification information of the TCI state; and/or
   Associated signal index information, different TCI states may be associated with different signal index information. In one example, signal index information corresponding to different TAGs is different, so signal index information corresponding to TCI states belonging to different TAGs is also different.

Step e1-1: The second network node transmits to the first network node the first notification message, which may include the following information:
Information related to timing advance (for the information contained in this information, please refer to the description in the Step 1-1 above); and/or
Information associated with timing advance information, which may include the following information:
   Signal index information.

Step e1-2: The first network node transmits to the user equipment the first command message, which may include the following information (for detailed description of the information contained in this message, please refer to the description in the Step 1-2 above):
Indication information of a cell;
Timing advance information; and/or
The identification information of the TCI state, and the “timing advance information” corresponding to this information is determined by the first network node according to the information obtained in the step e1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in the step e1-0 and the TA information received in the step e1-1. Specifically, the signal index information corresponding to each TCI state is configured in the step e1-0, while the step e1-1 contains the signal index information corresponding to the TA information, the first network node may determine the TA information corresponding to the “identification information of the TCI state” in step e1-2.
Method 6: Determine the TCI state or TAG corresponding to the TA information according to the second resource indication information (such as the resource used by the user equipment to transmit the uplink signal).

In this method, the first network node is pre-configured with the second resource corresponding to the TCI state (such as the resource used by the user equipment to transmit a preamble), and then the first network node may receive the TA information and the second resource indication information from the second network node, so that the TA information corresponding to the TCI state can be determined, so that when transmitting a handover command to the user equipment, the TA information corresponding to the TCI state can be provided according to the identification information of the TCI state in the command. Specifically, it includes the following steps:

Step f1-0: The third network entity or the third network node transmits to the first network node the first configuration message, which may include the following information (for other information contained in this message, please refer to the description in the Step 1-0 above):
Information related to a TCI state, which may include the following information:
   Identification information of the TCI state; and/or
   Associated second resource indication information, different TCI states may be associated with different second resources. In one example, different TAGs correspond to different second resources, so TCI states belonging to different TAGs also correspond to different second resources.

Step f1-1: The second network node transmits to the first network node the first notification message, which may include the following information:
Information related to timing advance (for the information contained in this information, please refer to the description in the Step 1-1 above); and/or
Information associated with timing advance information, which may include the following information:
   Second resource indication information.

Step f1-2: The first network node transmits to the user equipment the first command message, which may include the following information (for detailed description of the information contained in this message, please refer to the description in the Step 1-2 above):
Indication information of a cell;
Timing advance information; and/or
Identification information of the TCI state, and the “timing advance information” corresponding to this information is determined by the first network node according to the information obtained in the step f1-1. Specifically, the first network node determines the target cell or candidate cell to be accessed by the user equipment and the TCI state (i.e., “identification information of the TCI state”) required for accessing the cell, and then determines the TA information corresponding to the TCI state according to the configuration in the step f1-0 and the TA information received in the step f1-1. Specifically, the second resource indication information corresponding to each TCI state is configured in the step f1-0, while the step f1-1 contains the second resource indication information corresponding to the TA information, the first network node may determine the TA information corresponding to the “identification information of the TCI state” in the step f1-2.

FIG. 3 illustrates a flowchart of a first example interaction between network nodes and a user equipment according to an example embodiment of the present disclosure.

According to different nodes corresponding to the first network node, the second network node and the third network node, the above process may have the following different embodiments:

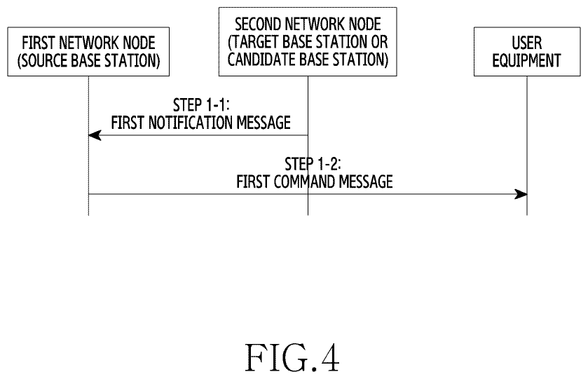

Embodiment 1: The first network node is a base station (a source base station, such as the second node) serving a source cell, and the second network node is a base station (a target base station, or a candidate base station, such as the fourth node) serving a target cell or a candidate cell. The example interaction process between the network nodes and the user equipment of this embodiment is shown in FIG. 4.

Step 1-1: The second network node transmits the first notification message (such as a TA information notification message) to the first network node.

Step 1-2: The first network node transmits the first command message (such as an LTM cell switch MAC CE) to the user equipment.

The above step 1-0 is not included in this embodiment.

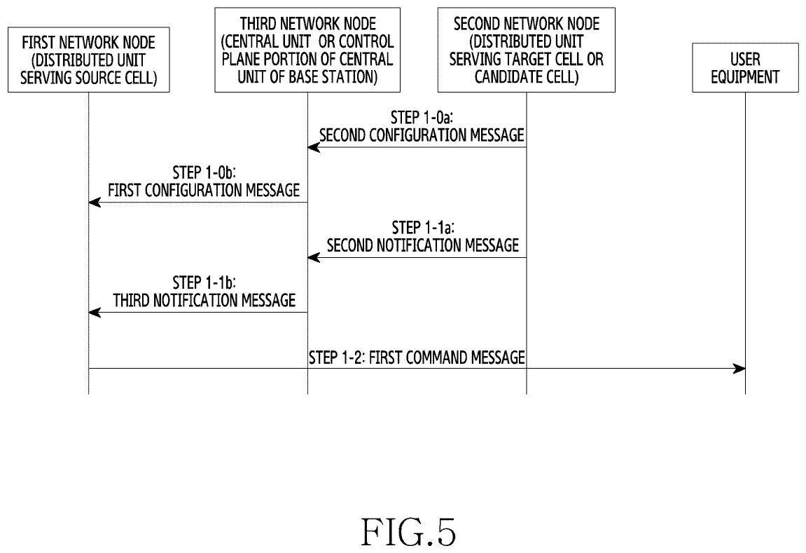

Embodiment 2: The first network node is a distributed unit (such as the third node) of the base station serving the source cell, the second network node is a distributed unit (such as the fifth node) of the base station serving the target cell or the candidate cell, and the third network node is a central unit of the base station or a control plane portion of the central unit of the base station (such as the second node) controlling the first network node and the second network node. An example interaction process between the network nodes and the user equipment of this embodiment is shown in FIG. 5.

### Configuration Stage

Step 1-0a: The second network node transmits a second configuration message (such as a UE context setup/modification response message) to the third network node, and for the information contained in this message, please refer to the description in the first configuration message. Through the step 1-0a, the third network node may collect information of different target cells or candidate cells.

Step 1-0b: The third network node transmits a first configuration message (such as a UE context modification response message) to the first network node.

### Ta Information Acquisition Stage

Step 1-1a: The second network node transmits a second notification message (such as a DU-CU TA information notification message) to the third network node, and for the information contained in this message, please refer to the description in the first notification message.

Step 1-1b: The third network node transmits a third notification message (such as a CU-DU TA information notification message) to the first network node, and for the information contained in this message, please refer to the description in the first notification message.

### Handover Stage

Step 1-2: The first network node transmits a first command message (such as an LTM cell switch MAC CE) to the user equipment.

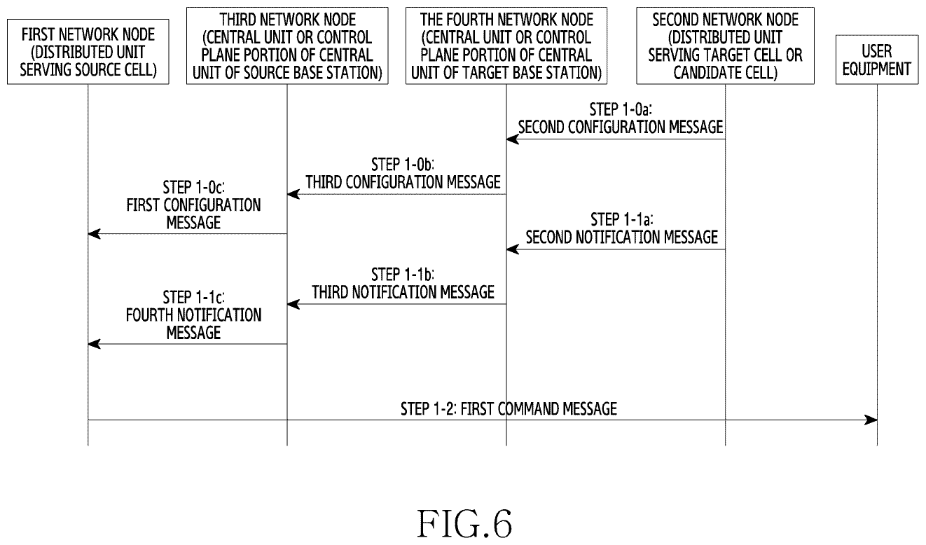

Embodiment 3: The first network node is a distributed unit (such as the third node) of a base station serving a source cell, the second network node is a distributed unit (such as the fifth node) of a base station serving a target cell or a candidate cell, the third network node is a central unite of a base station or a control plane portion (such as the second node) of the central unit of the base station controlling the first network node, and the fourth network node is a central unit of a base station or a control plane portion (such as the fourth node) of the central unit of the base station controlling the second network node. An example interaction process between the network nodes and the user equipment of this embodiment is shown in FIG. 6.

### Configuration Stage

Step 1-0a: The second network node transmits a second configuration message (such as a UE context setup/modification response message) to the fourth network node, and for the information contained in this message, please refer to the description in the first configuration message.

Step 1-0b, the fourth network node transmits a third configuration message (such as a Handover Request Acknowledge message) to the third network node, and for the information contained in this message, please refer to the description in the first configuration message. Through the above two steps, the third network node may collect information of different target cells or candidate cells.

Step 1-0c: The third network node transmits a first configuration message (such as a UE context modification request message) to the first network node.

### Ta Information Acquisition Stage

Step 1-1a: The second network node transmits a second notification message (such as a DU-CU TA information notification message) to the fourth network node, and for the information contained in this message, please refer to the description in the first notification message.

Step 1-1b: The fourth network node transmits a third notification message (such as a TA information notification message) to the third network node, and for the information contained in this message, please refer to the description in the first notification message.

Step 1-1c: The third network node transmits a fourth notification message (such as a CU-DU TA information notification message) to the first network node, and for the information contained in this message, please refer to the description in the first notification message.

### Handover Stage

Step 1-2: The first network node transmits a first command message (such as an LTM cell switch MAC CE) to the user equipment.

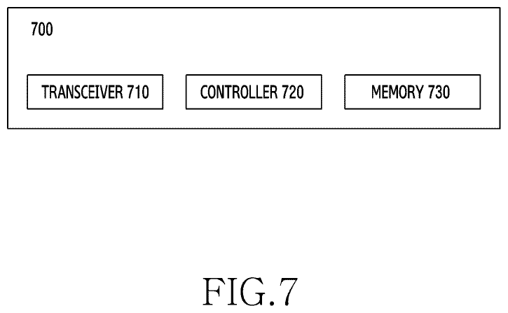

FIG. 7 illustrates a node according to an example embodiment of the present disclosure. Here, a node is taken as an example to explain its structure and function, but it should be understood that the shown structure and function can also be applied to base stations (or central units of base stations, or control plane portions of central units of base stations, or user plane portions of central units of base stations, or distributed units of base stations, or network nodes, etc.).

Referring to FIG. 7, a node 700 includes a transceiver 710, a controller 720 and a memory 730. Under the control of the controller 720, which may be implemented as one or more processors, the node 700 (including the transceiver 710 and the memory 730) is configured to perform the operations of the node described herein. Although the transceiver 710, the controller 720 and the memory 730 are shown as separate entities, they may be implemented as a single entity, such as a single chip. The transceiver 710, the controller 720 and the memory 730 may be electrically connected or coupled to each other. The transceiver 710 can transmit and receive signals to and from other network entities, such as another node and/or UE. In one embodiment, the transceiver 710 may be omitted. In this case, the controller 720 may be configured to execute instructions (including computer programs) stored in the memory 730 to control the overall operation of the node 700, thereby realizing the operation of the node described herein.

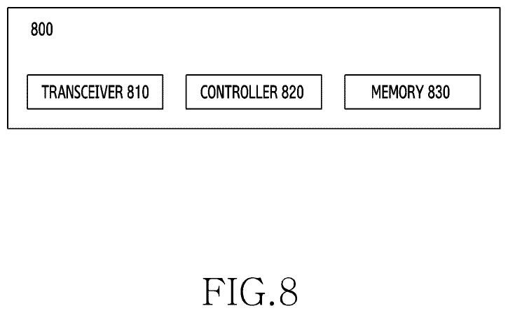

FIG. 8 illustrates a user equipment according to an example embodiment of the present disclosure.

Referring to FIG. 8, a user equipment 800 includes a transceiver 810, a controller 820 and a memory 830. Under the control of the controller 820, which may be implemented as one or more processors, the user equipment 800 (including the transceiver 810 and the memory 830) is configured to perform the operations of the user equipment described herein. Although the transceiver 810, the controller 820 and the memory 830 are shown as separate entities, they may be implemented as a single entity, such as a single chip. The transceiver 810, the controller 820 and the memory 830 may be electrically connected or coupled to each other. The transceiver 810 can transmit and receive signals to and from other network entities, such as a node, another UE, and the like. In one embodiment, the transceiver 810 may be omitted. In this case, the controller 820 may be configured to execute instructions (including computer programs) stored in the memory 830 to control the overall operation of the user equipment 800, thereby performing the operations of the user equipment described herein.

According to some embodiments, the memory 730 and/or 830 of the present disclosure may include a non-transitory computer-readable medium storing one or more instructions for communication. The one or more instructions, when executed by the controller 720 and/or 820, cause the node 700 and/or the user equipment 800 to perform various operations in the methods of the node and/or the user equipment described herein.

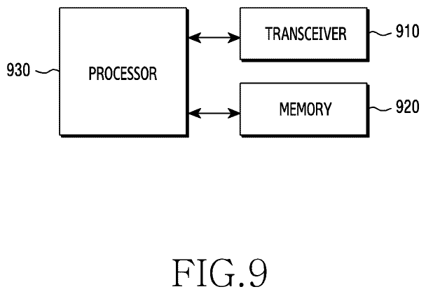

FIG. 9 illustrates a structure of a UE according to an embodiment of the present disclosure.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 collectively refers to a UE receiver and a UE transmitter, and may transmit/receive a signal to/from a base station. The signal transmitted or received to or from the base station may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station, and the processor 930 may determine a result of receiving the control signal and the data signal transmitted by the base station.

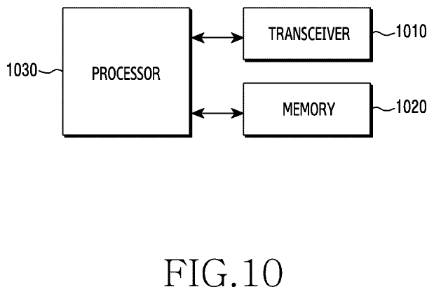

FIG. 10 illustrates a structure of a network node according to an embodiment of the present disclosure. The network node of FIG. 10 comprises a central unit (CU) of the base station or a distributed unit (DU) of the base station.

As shown in FIG. 10, the network node according to an embodiment may include a transceiver 1010, a memory 1020, and a processor 1030. The transceiver 1010, the memory 1020, and the processor 1030 of the network node may operate according to a communication method of the network node described above. However, the components of the network node are not limited thereto. For example, the network node may include more or fewer components than those described above. In addition, the processor 1030, the transceiver 1010, and the memory 1020 may be implemented as a single chip. Also, the processor 1030 may include at least one processor.

The transceiver 1010 collectively refers to a network node receiver and a network node transmitter, and may transmit/receive a signal to/from a terminal. The signal transmitted or received to or from the terminal may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the network node. Also, the memory 1020 may store control information or data included in a signal obtained by the network node. The memory 1020 may be a storage medium, such as read-only memory (ROM), random access memory (RAM), a hard disk, a CD-ROM, and a DVD, or a combination of storage media.

The processor 1030 may control a series of processes such that the network node operates as described above. For example, the transceiver 1010 may receive a data signal including a control signal transmitted by the terminal, and the processor 1030 may determine a result of receiving the control signal and the data signal transmitted by the terminal.

According to some embodiments, the user equipment described in the present disclosure may include a cellular or other communication device having a single-line display or a multi-line display or a cellular or other communication device without a multi-line display; personal communications service (PCS), which can combine voice, data processing, fax and/or data communication capabilities; personal digital assistant (PDA), which may include RF receiver, pager, Internet/Intranet access, web browser, notepad, calendar and/or GPS (Global Positioning System) receiver; a conventional laptop and/or palmtop computer or other device having and/or including a radio frequency receiver. As used herein, “terminal” and “terminal device” can be portable, transportable, installed in vehicles (air, sea, and/or land), or suitable and/or configured to operate locally, and/or operate in any other location on the earth and/or space in a distributed form. The “terminal” and “terminal device” used here can also be communication terminals, internet terminals and music/video playing terminals, such as PDA, mobile internet device (Mobile Internet Device) and/or mobile phone with music/video playing function, as well as smart TV, set-top box, and other devices.

Those skilled in the art can realize that the disclosure can be realized in other specific forms without changing the technical idea or basic features of the disclosure. Therefore, it should be understood that the above-mentioned embodiments are only examples and are not limited. The scope of the present disclosure is defined by the appended claims rather than by the detailed description. Therefore, it is to be understood that all modifications or changes derived from the meaning and scope of the appended claims and their equivalents are within the scope of this disclosure.

In the above embodiments of the present disclosure, all operations and messages may be selectively performed or may be omitted. Furthermore, the operations in each embodiment do not need to be performed sequentially, and the order of the operations can be changed. Messages do not need to be transmitted in order, and the transmission order of messages may change. Each operation and each message transfer can be performed independently.

Although the present disclosure has been shown and described with reference to various embodiments thereof, it will be understood by those skilled in the art that various changes in form and details may be made without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A distributed unit (DU) in a wireless communication system, the DU comprising:
a transceiver; and
a controller coupled with the transceiver, and configured to:
receive, from a central unit (CU), a first message including configuration information for a candidate cell,
receive, from the CU, a second message including timing advance (TA) information for the candidate cell, wherein the TA information includes a TA value and a TA group (TAG) identifier (ID) pointer indicating that a transmission configuration indicator (TCI) state is associated with a first TAG or a second TAG, and
transmit, to a user equipment (UE), a medium access control (MAC) control element (CE) including the TA value and a TCI state ID of the TCI state, wherein the TA value is for the first TAG or the second TAG based on which the TCI state is associated according to the TAG ID pointer.

2. The DU of claim 1, wherein the configuration information includes first information configuring a cell ID for the candidate cell and second information configuring at least one TCI state associated with the candidate cell.

3. The DU of claim 1, wherein the TA information further includes a cell ID for the candidate cell,
wherein the MAC CE further includes an ID of the configuration information for the candidate cell, and
wherein the TCI state ID is for a joint TCI state or a downlink TCI state.

4. The DU of claim 1, wherein the first message is a UE context modification request message,
wherein the second message is a TA information transfer message, and
wherein the MAC CE is a layer 1/layer 2 triggered mobility (LTM) cell switch command MAC CE.

5. A central unit (CU) in a wireless communication system, the CU comprising:
a transceiver; and
a controller coupled with the transceiver, and configured to:
transmit, to a distributed unit (DU), a first message including configuration information for a candidate cell, and
transmit, to the DU, a second message including timing advance (TA) information for the candidate cell, wherein the TA information includes a TA value and a TA group (TAG) identifier (ID) pointer indicating that a transmission configuration indicator (TCI) state is associated with a first TAG or a second TAG.

6. The CU of claim 5, wherein the configuration information includes first information configuring a cell ID for the candidate cell and second information configuring at least one TCI state associated with the candidate cell.

7. The CU of claim 5, wherein the TA information further includes a cell ID for the candidate cell.

8. The CU of claim 5, wherein the first message is a UE context modification request message, and
wherein the second message is a TA information transfer message.

9. A method performed by a distributed unit (DU) in a wireless communication system, the method comprising:
receiving, from a central unit (CU), a first message including configuration information for a candidate cell;
receiving, from the CU, a second message including timing advance (TA) information for the candidate cell, wherein the TA information includes a TA value and a TA group (TAG) identifier (ID) pointer indicating that a transmission configuration indicator (TCI) state is associated with a first TAG or a second TAG; and
transmitting, to a user equipment (UE), a medium access control (MAC) control element (CE) including the TA value and a TCI state ID of the TCI state, wherein the TA value is for the first TAG or the second TAG based on which the TCI state is associated according to the TAG ID pointer.

10. The method of claim 9, wherein the configuration information includes first information configuring a cell ID for the candidate cell and second information configuring at least one TCI state associated with the candidate cell.

11. The method of claim 9, wherein the TA information further includes a cell ID for the candidate cell,
wherein the MAC CE further includes an ID of the configuration information for the candidate cell, and
wherein the TCI state ID is for a joint TCI state or a downlink TCI state.

12. The method of claim 9, wherein the first message is a UE context modification request message,
wherein the second message is a TA information transfer message, and
wherein the MAC CE is a layer 1/layer 2 triggered mobility (LTM) cell switch command MAC CE.

13. A method performed by a central unit (CU) in a wireless communication system, the method comprising:
transmitting, to a distributed unit (DU), a first message including configuration information for a candidate cell; and
transmitting; to the DU, a second message including timing advance (TA) information for the candidate cell, wherein the TA information includes a TA value and a TA group (TAG) identifier (ID) pointer indicating that a transmission configuration indicator (TCI) state is associated with a first TAG or a second TAG.

14. The method of claim 13, wherein the configuration information includes first information configuring a cell ID for the candidate cell and second information configuring at least one TCI state associated with the candidate cell.

15. The method of claim 13, wherein the TA information further includes a cell ID for the candidate cell.

16. The method of claim 13, wherein the first message is a UE context modification request message, and
wherein the second message is a TA information transfer message.
